(19) United States
(12) Patent Application Publication
(10) Pub. No.: US 2017/0073069 A1
(43) Pub. Date: Mar. 16, 2017

(54) SECURITY SYSTEM

(71) Applicant: Chunghwa Picture Tubes, LTD., Taoyuan City (TW)

(72) Inventors: Wen-Hsiang Kao, Kaohsiung City (TW); Pin-Hung Chou, Taipei City (TW)

(21) Appl. No.: 14/932,985

(22) Filed: Nov. 5, 2015

(30) Foreign Application Priority Data
Sep. 10, 2015 (TW) 104214660

(51) Int. Cl. B64C 39/02; G06K 9/00

(52) U.S. Cl. CPC B64C 39/024; G06K 9/00288; B64C 2201/024; B64C 2201/146; B64C 2201/12; B64C 2201/123

(57) ABSTRACT

A security system is provided. An unmanned flying vehicle is remotely controlled to collect an environment information of a target environment, and whether a prompt signal is outputted is determined according to an environment variation obtained by comparing the environment information with a reference environmental information.

### CROSS-REFERENCE TO RELATED APPLICATION

This application claims the priority benefit of Taiwan application serial no. 104214660, filed on Sep. 10, 2015. The entirety of the above-mentioned patent application is hereby incorporated by reference herein and made a part of this specification.

### BACKGROUND OF THE INVENTION

Field of the Invention

The invention relates to an electronic apparatus, and particularly relates to a security system.

Description of Related Art

As technology advances and quality of life is increased, security of the living environment has become an important issue. Safety of living covers households, offices, laboratories, factories, financial institutions, and other public places. As a result, many industries have devoted more effort into developing different types of security systems, causing the security industry to become a rapidly developing field. In the area of security, security patrol is among the tasks security personnel are least willing to perform. Although operation requirements of security personnel can be mandated by systems, many factors (physical and mental) that are beyond control may still may cause security personnel to be unable to execute duties thoroughly. Additionally, when the coverage of patrol is greater, security personnel are unable to collect information of abnormality such as moving intruder, fire smoke, gas, etc. within a short time, thus resulting in loophole in security.

### SUMMARY OF THE INVENTION

Accordingly, the invention provides a security system that effectively fills loopholes in security and ensures personal or property safety. The security system of the invention includes an unmanned flying vehicle and a control apparatus. The control apparatus wirelessly communicates with the unmanned flying vehicle to remotely control the unmanned flying vehicle in order to collect an environment information of a target environment, and the control apparatus compares the environment information to a reference environment information in order to obtain an environment variation information, and determine whether a prompt signal is outputted according to the environment variation information.

In an embodiment of the invention, the above described environment information includes a spatial location distribution of an object of the target environment, a personnel information of the target environment, and a temperature and a gas composition of the target environment.

In an embodiment of the invention, the above described control apparatus determines whether a variation percentage of the spatial location of the object of the target environment exceeds a predetermined threshold value, and if the variation percentage of the spatial location of the object of the target environment exceeds the predetermined threshold value, the prompt signal is outputted.

In an embodiment of the invention, if the variation percentage of the object of the spatial location of the object of the target environment exceeds the predetermined threshold value, the control apparatus further remotely controls the unmanned flying vehicle to collect an image information of the object having the variation in the spatial location of the target environment spatial location, and control the the unmanned flying vehicle to transmit back the image information.

In an embodiment of the invention, the above described reference environment information includes an identification reference information of a number of predetermined personnel, and the control apparatus compares the personnel information of the target environment to the identification reference information of the predetermined personnel in order to determine whether the personnel of the target environment are of the predetermined personnel, and if the personnel of the target environment is not of the predetermined personnel, the prompt signal is outputted.

In an embodiment of the invention, the above described control apparatus determines whether the temperature of the target environment exceeds a predetermined threshold temperature, and if the temperature of the target environment exceeds the predetermined threshold temperature, the prompt signal is outputted.

In an embodiment of the invention, the above described control apparatus determines whether a concentration of a certain gas of the target environment exceeds a predetermined threshold concentration, and if the concentration of the certain gas of the target environment exceeds the predetermined threshold concentration, the prompt signal is outputted.

In an embodiment of the invention, the above described unmanned flying vehicle includes a communication unit and a control unit. The control unit communicates with the control apparatus through the communication unit, and is controlled by the control apparatus to control the unmanned flying vehicle to collect the environment information.

In an embodiment of the invention, the above described security system includes a spatial detection unit coupled to the control unit and controlled by the control unit to detect the spatial location distribution of the object of the target environment.

In an embodiment of the invention, the above described security system includes a facial recognition unit coupled to the control unit and controlled by the control unit to recognize a face of the personnel of the target environment.

In an embodiment of the invention, the above described security system includes a photograph unit coupled to the control unit and is controlled by the control unit to photograph the target environment.

In an embodiment of the invention, the above described reference environment information is a previous environment information of the target environment collected by the unmanned flying vehicle.

In an embodiment of the invention, the control apparatus further plans a flight path and a flight schedule according to to the environment information and the reference environment information.

In an embodiment of the invention, the above described control apparatus further receives a power information of the unmanned flying vehicle from the unmanned flying vehicle, and remotely controls the unmanned flying vehicle to fly to a charging location for charging according to the power information.

As described above, the embodiments of the invention collect the environment information of the target environment by remotely controlling the unmanned flying vehicle, and determine whether a prompt signal is outputted according to the variation information of the environment obtained by comparing the environment information to the reference environment information. When implemented in this manner, the high mobility of the unmanned flying vehicle can quickly and effectively collect variation information, such that security loopholes are filled to ensure personal or property safety.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic of a security system of the invention according to an embodiment of the invention.

FIG. 2 is a schematic of an unmanned flying vehicle of the invention according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

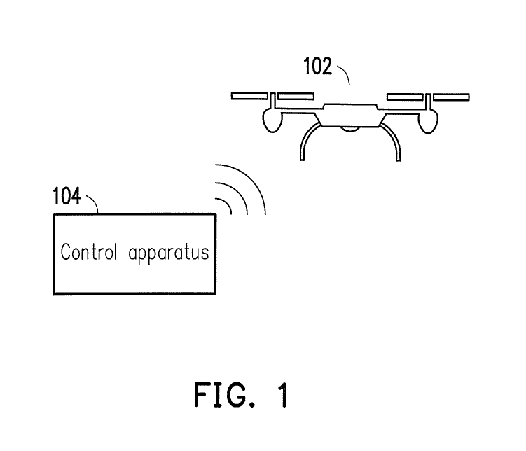

FIG. 1 is a schematic of a security system according to an embodiment of the invention. Please refer to FIG. 1. The security system includes an unmanned flying vehicle 102 and a control apparatus 104. The controller 104 is can communicate with the unmanned flying vehicle 102 in order to remotely control the unmanned flying vehicle 102 to collect an environment information of a target environment, and compares the environment information with a reference environment information in order to obtain an environment variation information, and then determine whether a prompt signal is outputted according to the environment variation information. The reference environment information may be, for instance, an environment information of the target environment previously collected by the unmanned flying vehicle 102. The information may be for instance stored in the control apparatus 104 or may also be stored in a remote storage device connected to the control apparatus, such as a cloud server. The environment information may include for instance a spatial location distribution of the object of the target environment, a personnel information of the target environment, a temperature, a gas composition of the target environment, etc. Furthermore, the prompt signal may be for instance outputted in light or sound forms. For instance an alarm device, or a warning frame through a display device. The warning frame may be, for instance, warning language and an image of the present environment information collected.

More particularly, the control apparatus 104 can determine whether the object of the target environment is moved by comparing the spatial location distribution of the object of the target environment to the spatial location distribution of the object of the reference environment information collected by the unmanned flying vehicle 102. For instance, whether a variance percentage of the spatial location of the object of the target environment exceeds a predetermined threshold is determined. If the variance percentage of the spatial location of the object of the target environment exceeds the threshold value (e.g., when the variance percentage exceeds 50%), the prompt is outputted in order to prompt a user of the related variance message of the target environment. If the threshold value is not exceeded, then the environment information continues to be collected. In some of the embodiments, if the control apparatus 104 determines that the variance percentage of the spatial location of the object of the target environment exceeds the predetermined threshold value, the control apparatus 104 can further controlling the unmanned flying vehicle 102 to collect an image information specific to the part of the target environment having the variance, and transmit back the collected image information to the control apparatus 104 for the control apparatus 104 to provide the image information transmitted back to the user as part of a prompt message.

Additionally, regarding the personnel information of the target environment, the reference environment information may include an identification reference information of a number of personnel. The control apparatus 104 can compare the personnel information of the target environment collected by the unmanned flying vehicle 102 to the identification reference information in order to determine whether a personnel of the target environment is of a predetermined personnel. If the personnel of the target environment is not of the predetermined personnel, it means there an intruder has intruded the target environment. The control apparatus 104 may output the prompt message to the user at this time. Similarly, the control apparatus 104 can also further control the unmanned flying vehicle 102 to collect personnel information of the target environment, and transmit back the collected image information to the control apparatus 104 for the control apparatus 104 to provide to the user, as part of a prompt message, the image information transmitted back.

Further, regarding the temperature and the gas composition of the target environment, the reference environment information may include threshold information such as a predetermined temperature and a predetermined concentration. The control apparatus 104 can compare the temperature of the target environment and a certain gas concentration detected by the unmanned flying vehicle 102 to the threshold information in order to determine whether the temperature and the gas concentration have reached an alarming level, and output the prompt message to the user accordingly. For instance, the control apparatus 104 can determine whether the temperature of the target environment exceeded the predetermined temperature. If the temperature of the target environment exceeds the predetermined temperature, then prompt signal is outputted. As another instance, the control apparatus 104 can determine whether the concentration of the certain gas of the target environment has exceeds the predetermined concentration. If the concentration of the target environment exceeds the predetermined concentration, then the prompt signal is outputted.

Furthermore, the control apparatus 104 can plan a flight path and a flight schedule of the unmanned flying vehicle 102 according to the environment information and the reference environment information, in order to ensure the unmanned flying vehicle 102 collects the environment information in the target environment in the most efficient way, such that the unmanned flying vehicle 102 to collects the environment information in the target environment according to the flight schedule, in order to ensure the personal and property safety of the user. The control apparatus 104 can further receive a power information of the unmanned flying vehicle from the unmanned flying vehicle 102 and remotely control the unmanned flying vehicle 102 to fly to the charging location for charging according to the power information, so as to prevent the execution of a mission of collection of environment information collection from being affected by insufficient power.

More particularly, before the user goes to bed, the user may control the unmanned flying vehicle 102 to collect the environment information inside and outside of the house (e.g., swimming pool, garage, storage, garden, etc.) as the reference environment information, and through the control apparatus plan the patrol location and the patrol schedule of the unmanned flying vehicle 102 through the control apparatus so as to control the control apparatus 104 to plan the flight path and the flight schedule of the unmanned flying vehicle 102. After the user goes to bed, the controller 104 controls the unmanned flying vehicle 102 to collect the environment information of the target environment (i.e., inside and outside of the house) according to the flight path and the flight schedule. As described in the above embodiments, the control apparatus can compare the environment information collected to the reference environment information, so as to determine whether or not to output the prompt message. For instance determine whether objects of the house or outside the house are moved (i.e., whether variance exists in the spatial location of the objects of the target environment) is determined, whether there is intrusion by personnel other than family members (i.e., the above described predetermined personnel), whether the temperature exceeds the predetermined temperature (to determine whether a fire is present) is determined, and whether a certain gas has exceeds the predetermined concentration (e.g., whether the carbon monoxide concentration is too high) is determined, and whether to output the prompt message is determined according to the results of determination, in order to effectively protect the personal and property safety of the user.

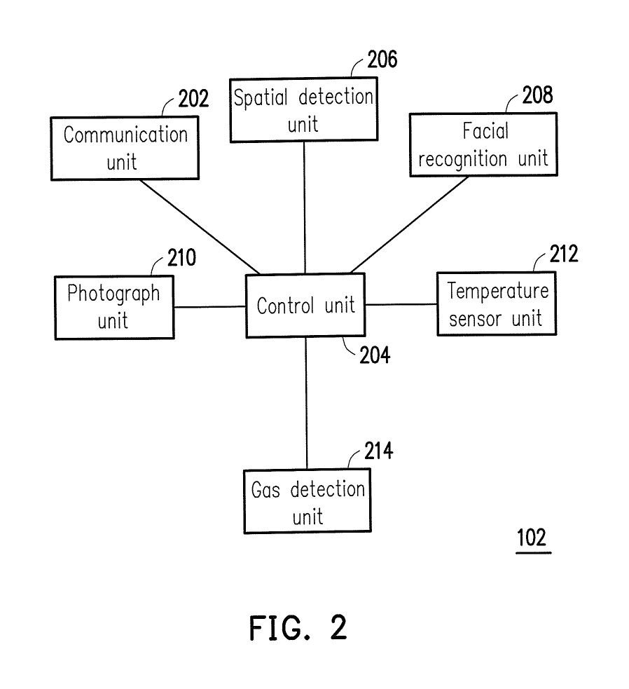

FIG. 2 is a schematic of the unmanned flying vehicle 102 of the invention according to an embodiment of the invention. Please refer to FIG. 2. Furthermore, the above described unmanned flying vehicle 102 may include for instance an aircraft and elements shown in FIG. 2, i.e., communication unit 202, control unit 204, space detection unit 206, facial recognition unit 208, photograph unit 210, temperature sensor unit 212, and gas detection unit 214, wherein the communication unit 202, the space detection unit 206, the facial recognition unit 208, and the photograph unit 210 are coupled to the control unit 204. The control unit 204 can communicate with the control apparatus 104 via the communication unit 202, and is controlled by the control apparatus 104 to control the unmanned flying vehicle 102 to collect the environment information, e.g., collect environment information of the target environment according to the flight path and the flight schedule planned by the control apparatus 104. Additionally, the control unit 204 can also receive the power information of the unmanned flying vehicle 102 via the communication unit 202, and remotely control the unmanned flying vehicle 102 to move to the charging location for charging according to the power information. The space detection unit 206 can be controlled by the control unit 204 and detect the spatial location distribution of the target environment. It may be implemented by, for instance, as ultrasonic message transmitter and an ultrasonic message receiver. Additionally, the photograph unit 210 is can also photograph images of the target environment. The facial recognition unit 208 can be adapted to detect the faces of personnel in the target environment. It may be implemented by for instance an infrared radiation camera and a depth sensor, wherein the depth sensor can retrieve three-dimensional depth information of the face of a human, so as to ensure the subject is not a two-dimensional photo. Further, the temperature sensor unit 212 and the gas detection unit 214 can respectively detect the temperature and the gas composition of the target environment, wherein the temperature sensor unit 212 may be for instance implemented by an infrared temperature sensor, and the gas detection unit 214 may be, for instance, implemented by a carbon monoxide detector, and this invention is not limited hereto.

As described above, the embodiments of the invention collect the environment information of the target environment by remotely controlling the unmanned flying vehicle, and determine whether a prompt signal is outputted according to the variation information of the environment obtained by comparing the environment information to the reference environment information. When implemented in this manner, the high mobility of the unmanned flying vehicle can quickly and effectively collect variation information, such that security loopholes are filled to ensure personal or property safety.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A security system, comprising:
an unmanned flying vehicle; and
a control apparatus wirelessly communicating with the unmanned flying vehicle to remotely control the unmanned flying vehicle to collect an environment information of a target environment, and comparing the environment information with a reference environment information, and determining whether a prompt signal is outputted according to an environment variation.

2. The security system as claimed in claim 1, wherein the environment information comprises a spatial location distribution of an object of the target environment, a personnel information of the target environment, and a temperature and a gas composition of the target environment.

3. The security system as claimed in claim 2, wherein the control apparatus determines whether a variation percentage of the spatial location of the object of the target environment exceeds a predetermined threshold value, and if the variation percentage of the spatial location of the object of the target environment exceeds the predetermined threshold value, the prompt signal is outputted.

4. The security system as claimed in claim 3, wherein if the variation percentage of the spatial location of the object of the target environment exceeds the predetermined threshold value, the control apparatus further remotely controls the unmanned flying vehicle to collect an image information of the object having the variation in the spatial location of the target environment, and control the unmanned flying vehicle to transmit back the image information.

5. The security system as claimed in claim 2, wherein the reference environment information comprises an identification reference information of a number of predetermined personnel, and the control apparatus compares the personnel information of the target environment to the identification reference information of the predetermined personnel in order to determine whether the personnel of the target environment are of the predetermined personnel, and if the personnel of the target environment is not of the predetermined personnel, the prompt signal is outputted.

6. The security system as claimed in claim 2, wherein the control apparatus determines whether the temperature of the target environment exceeds a predetermined threshold temperature, and if the temperature of the target environment exceeds the predetermined threshold temperature, the prompt signal is outputted.

7. The security system as claimed in claim 2, wherein the control apparatus determines whether the concentration of a certain gas of the target environment exceeds a predetermined concentration, and if the concentration of the certain gas of the target environment exceeds the predetermined concentration, the prompt signal is outputted.

8. The security system as claimed in claim 1, wherein the unmanned flying vehicle comprises:
a communication unit; and
a control unit communicating with the control apparatus through the communication unit, and controlled by the control apparatus to control the unmanned flying vehicle to collect the environment information.

9. The security system as claimed in claim 8, further comprising:
a spatial detection unit coupled to the control unit and controlled by the control unit to detect the spatial location distribution of the object of the target environment.

10. The security system as claimed in claim 8, further comprising:
a facial recognition unit, coupled to the control unit and controlled by the control unit to recognize a face of the personnel of the target environment.

11. The security system as claimed in claim 8, further comprising:
a photograph unit coupled to the control unit and being controlled by the control unit to photograph the target environment.

12. The security system as claimed in claim 1, wherein the reference environment information is a previous environment information of the target environment collected by the unmanned flying vehicle.

13. The security system as claimed in claim 1, wherein the control apparatus further plans a flight path and a flight schedule according to to the environment information and the reference environment information

14. The security system as claimed in claim 1, wherein the control apparatus further receives a power information of the unmanned flying vehicle from the unmanned flying vehicle, and remotely controls the unmanned flying vehicle to fly to a charging location for charging according to the power information.
